(19) United States
(12) Patent Application Publication
(10) Pub. No.: US 2011/0161532 A1
(43) Pub. Date: Jun. 30, 2011

(54) TRANSCEIVER FOR WIRED SERIAL COMMUNICATION

(75) Inventors: Seth Prentice, Auburn, ME (US); Travis Williams, Portland, ME (US)

(73) Assignee: Fairchild Semiconductor Corporation, South Portland, ME (US)

(21) Appl. No.: 12/650,144

(22) Filed: Dec. 30, 2009

(51) Int. Cl. G06F 3/00; H04B 1/38; G06F 13/38

(52) U.S. Cl. 710/36; 375/219; 710/63

(57) ABSTRACT

This document discusses, among other things, transceiver apparatus and methods for wired serial communication to a remote device. The transceiver can be configured to generate an output signal using received compensation information to maintain a specified signal quality at the remote device. The transceiver can include an input for receiving first information, a compensation input for receiving the compensation information and an output to transmit the output signal including the first information to a component coupled between the transceiver and the remote device.

### BACKGROUND

Many standards have been developed for wired serial communication. The standards allow manufacturers of serial communication hardware, firmware and software to develop products in parallel that when interfaced, couple together mechanically and electrically to provide predictable and robust exchange of information between products. As a standard becomes more accepted in the market, product manufacturers look to distinguish their products by offering variations, including communication options that compliment the accepted communication standard. However, some communication standards do not allow much deviation, and thus require different support components, such as different transceivers, to support each variation of a product certified under that standard. Finding the specific support components, and stocking each, can be cost prohibitive and limit a product manufacturer's ability to fully compete in a product market.

### OVERVIEW

This document discusses, among other things, transceiver apparatus and methods for wired serial communication to a remote device. In an example, the transceiver can include an input for receiving first information, a compensation input for receiving compensation information, and an output for transmitting an output signal, including the first information, to a component coupled between the transceiver and the remote device. The transceiver can be configured to generate the output signal using the compensation information to maintain a specified signal quality at the remote device.

Another aspect of the disclosure includes a method for using an adjustable transceiver. In one example, the method includes receiving first information at an input of a transceiver. The transceiver is configured for wired serial communication to a remote device. The method also includes receiving compensation information using a compensation input of the transceiver, generating an output signal including the first information according to the compensation information, and transmitting the first information to the remote device. System examples employing an adjustable High Speed Universal Serial Bus transceiver are also provided.

The examples provided herein can be combined in any permutation or combination. This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 shows an adjustable transceiver according to one example of the present subject matter.

FIG. 2 shows an adjustable transceiver according to one example of the present subject matter.

FIG. 3 shows an adjustable transceiver according to one example of the present subject matter.

FIGS. 4A and 4B illustrate signal transitions of a serial communication system.

FIG. 5 shows a product with an adjustable transceiver according to one example of the present subject matter.

FIG. 6 shows a product including a transceiver according to one example of the present subject matter.

FIG. 7 illustrates generally a method of using an adjustable transceiver according to one example of the present subject matter.

FIG. 8 shows a method for receiving the compensation information and generating an output signal according to one example of the present subject matter.

FIG. 9 shows a method for receiving the compensation information and generating an output signal according to one example of the present subject matter.

### DETAILED DESCRIPTION

In various examples, a transceiver includes a data port (e.g., an input), a communication port (e.g., an output) and a compensation input. The data port exchanges information with a control device, such as a processor. The information can include data received at the communication port or data for transmission out of the communication port. The communication port can receive and transmit information with a remote device. In various examples, the communication port communicates with the remote device using a wired media. The transceiver can transmit information and can be configured to receive information at the communication port consistent with one or more specified standards, for example, but not limited to, Universal Serial Bus (USB) standards.

In an example, standards can allow manufacturers to build communication interfaces that are physically and electrically compatible. Various standards provide guidelines for signal characteristics, hardware characteristics, and hardware dimensions. For example, hardware standards can include, but are not limited to, connector shapes, termination counts, termination locations, termination configurations, and connector dimensions. Some wired, serial communication guidelines provide guidelines for signal levels and signal switching rates. For example, the high-speed USB 2.0 (HS USB 2.0) specification refers to “eye” compliance for signal morphology in providing specification limits of the signal levels and signal switching rates. Manufacturers of HS USB 2.0 compatible products can obtain certification, and label and advertise such certification, by meeting the specification guidelines. However, some products with wired serial communications capabilities can include features that do not allow a transceiver for one certified device to be used in a second device and yet still comply with the certification requirements in the second device. The present inventors have recognized, among other things, that an adjustable transceiver can allow a manufacturer to use a single transceiver in a variety of products yet still meet communication compliance even though those products can include components that distort the signals transmitted and received by the transceiver.

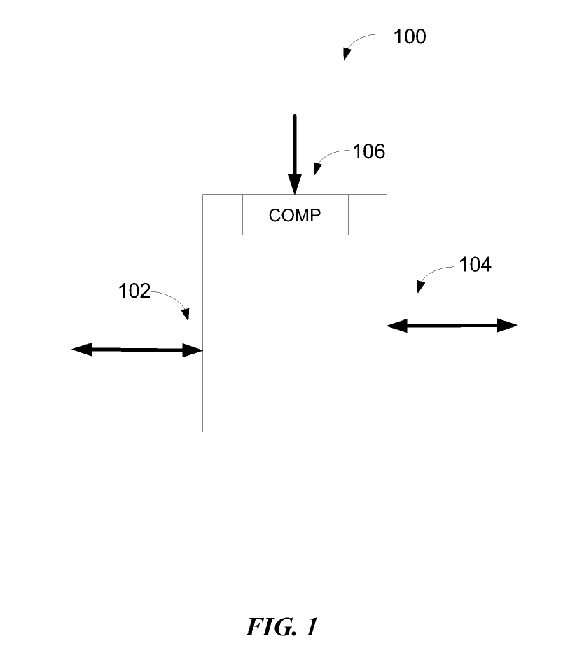

FIG. 1 shows an adjustable transceiver 100 according to one example of the present subject matter. The transceiver 100 can include a data port (input) 102, a communication port (output) 104 and a compensation input 106. The data port 102 can exchange information with a control device, such as a processor. The information can include data received at the communication port 102 or data for transmission out of the communication port 104. Additionally, the transceiver 100 can include a compensation input 106. The transceiver 100 can compensate for signal distortion of a component connected to the transceiver 100 by using a compensation setting that alters default signal strength of the transceiver 100. The compensation input 106 can be used to select the compensation setting that works best for product in which the adjustable transceiver 100 is used. For example, one setting can be used for a first cell phone having a switch coupled between the transceiver and a remote device. A second setting may work best for a similar, second cell phone model without the switch. Although compensation can be performed on both transmitted information and received information, the remainder of the description describes compensation for information transmitted from an adjustable transceiver.

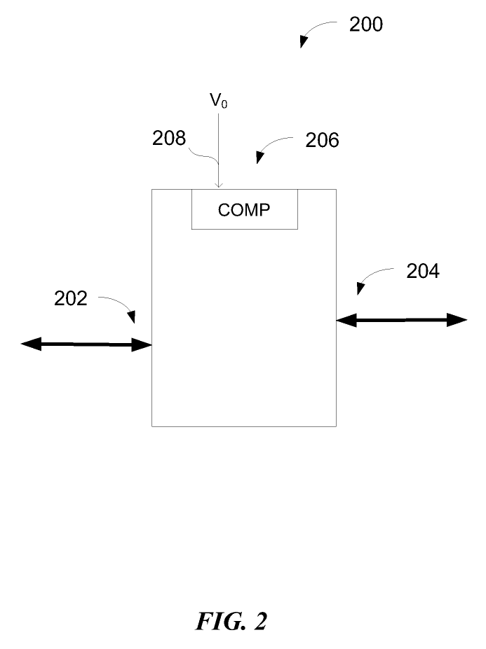

FIG. 2 shows an adjustable transceiver 200 according to one example of the present subject matter. The transceiver 200 can include a data port or input 202 for receiving information for transmission from a control device, a communication port or output 204 for transmitting the information from the transceiver, and a compensation input 206 for receiving compensation information for the transceiver. In various examples, the compensation information can be used to select settings of the output signal generated to transmit the information from the transceiver output 204. Settings of the transmission signal can include, but are not limited to, signal strength, signal amplitude, signal edge rates, signal frequency or combinations thereof. In various examples, the compensation input 206 can include a terminal 208. Upon installation of the transceiver 200 into a product, the terminal 208 can be connected to a reference to select a compensation setting for transmission of information from the output 204 of the transceiver 200. In various examples, the reference can be a voltage reference (V₀). It is understood that other references can be used without departing from the scope of the present subject matter including, for example, a current reference. In various examples, the transceiver 200 can operate under a default compensation setting if the compensation information at the compensation input is not clear, such as when a terminal is left floating. In some examples, the compensation input can include multiple terminals for selecting a compensation setting from several settings the transceiver is operable to implement.

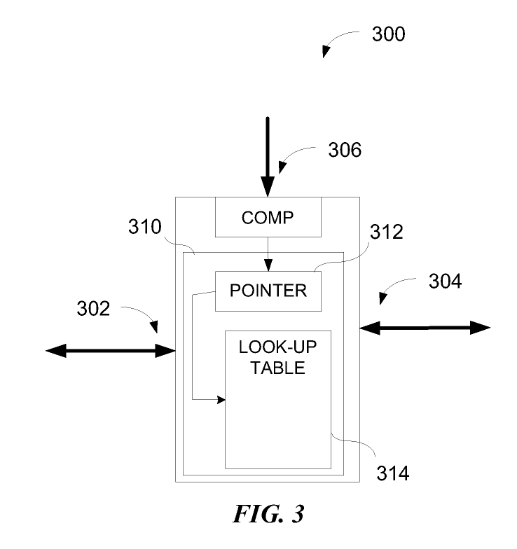

FIG. 3 shows an adjustable transceiver 300 according to one example of the present subject matter. The transceiver 300 can include an input 302 to receive information for transmission from the transceiver 300, an output 304 to transmit an output signal including the information to a remote device, and a compensation input 306 to receive compensation information to adjust the output signal for distortion caused using components coupled to the output 304 of the transceiver 300. In various examples, the compensation information can be used to select settings of the transmission signal used to transmit the information from the output 304. Settings of the transmission signal can include, but are not limited to, signal strength, signal amplitude, signal edge rates, signal frequency or combinations thereof. In various examples, the compensation input 306 can be coupled to a configuration circuit 310. The configuration circuit 310 can include a register 312, configured to receive a pointer value, and a look-up table 314. The look-up table 314 can be configured to store a plurality of compensation settings. The pointer register 312 can be programmed with a value indicating a position in the look-up table 314. The transceiver 300 can use one or more settings in the look-up table 314 indicated by the value in the register 312. The value in the register can point to the selected compensation settings. In various examples, the transceiver 300 can operate under a default compensation setting if the compensation information at the compensation input 306 is not clear, when the pointer value in the register is invalid, when the compensation settings are invalid, or combinations thereof. In some examples, the register value can be set using terminals of the transceiver 300, such that biasing one or more terminals to a selected reference sets a pointer value in the register 312. In some examples, the compensation input 306 can be included in the data port, or input 302, of the transceiver 300, such that the pointer register 306 is loaded through the input 302.

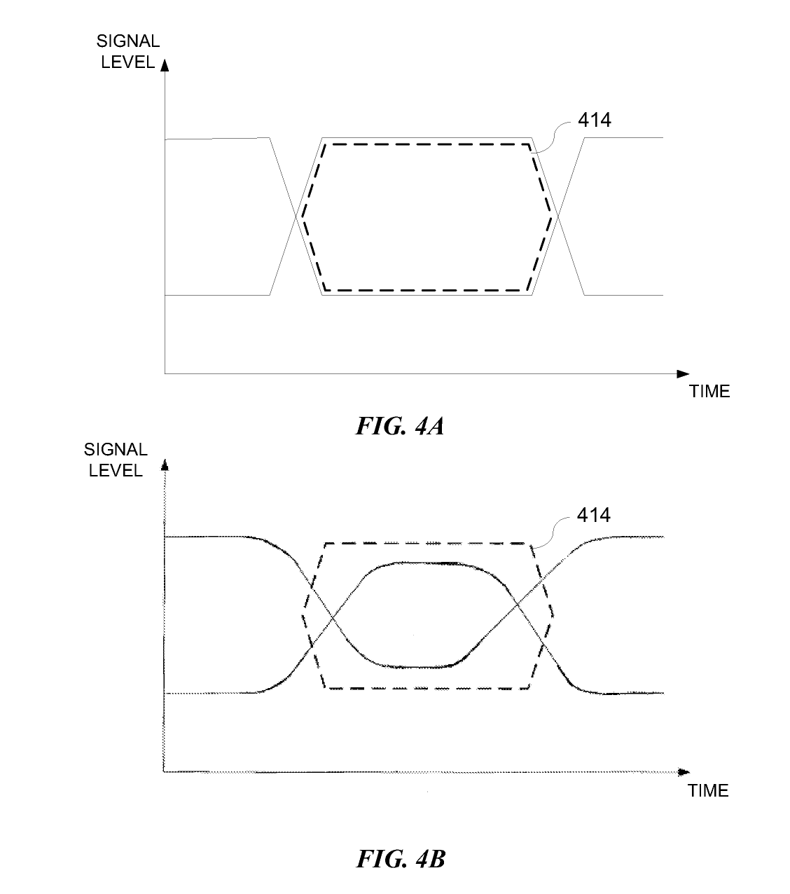

FIGS. 4A and 4B illustrate signal transitions of a serial communication system. FIG. 4A shows signal transitions at the output of a transceiver. The transitions can be typical of signal transitions that comply with a particular communication protocol. For example, the illustrated waveform is typical of a differential communication signal for a High Speed USB 2.0 communication system. The shape of the transition waveform can be referred to as an “eye” waveform. The “eye” shape 414 can be formed by the crossing levels of the two differential signals charted against time. Specifications, such as the HS USB 2.0 specification, can require that the signal levels and transitions of the “eye” conform to certain guidelines for certification of a device as HS USB 2.0 compliant. For example, in FIGS. 4A and 4B, compliance can be evaluated based on whether the signal waveform avoids intrusion of the “eye” shape 414. In certain examples, for transmitting, signals measured at a remote device must maintain the specified “eye” shape 414. In certain examples, for receiving, a device must be able to receive transmitted information if the received signal quality complies with the specification. However, a transceiver compliant when installed in one device may not be compliant when installed in another device. For example, FIG. 4B illustrates signal transitions from a transceiver capable of generating the compliant waveform of FIG. 4A. However, with respect to the waveform of FIG. 4B, a switch, such as a USB switch, can be installed between the transceiver and the remote device. The switch can distort the transmitted signal of the transceiver. The switch can distort the signal so much that the signal received at the remote device is no longer compliant with an intended specification, such as the illustrated “eye” shape 414.

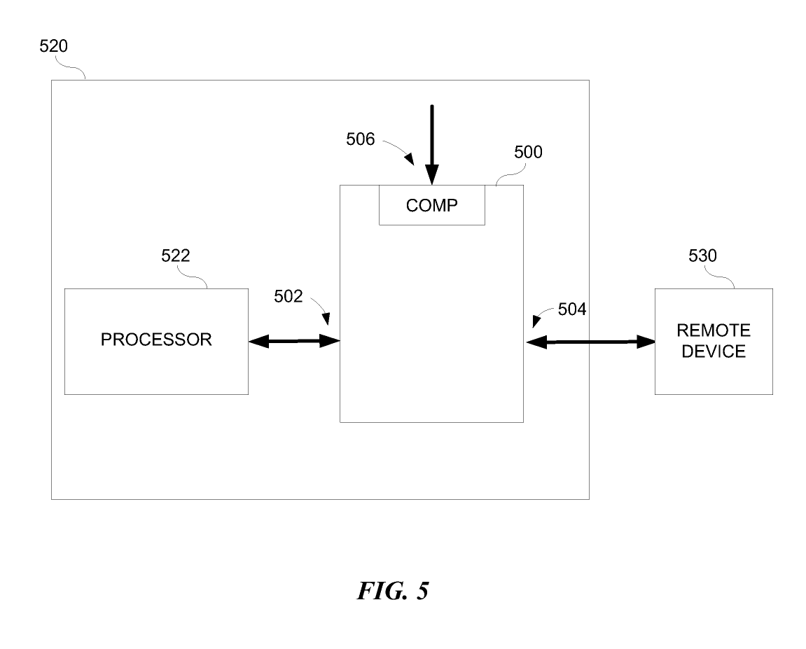

FIG. 5 shows a product 520 with an adjustable transceiver 500 according to one example of the present subject matter. The product 520 can be coupled to a remote device 530. The product 520 can include a processor 522 in communication with the transceiver 500. The transceiver 500 can include an input 502 for receiving information from the processor and an output 504 for transmitting an output signal, including the information, to the remote device 530. The transceiver 500 can include a compensation input 506 for receiving compensation information such that the output signal compensates for distortion between the product 520 and the remote device 530. Distortion can include, but is not limited to, signal strength attenuation including signal level attenuation and edge rate attenuation. The illustrated product 520 can show the adjustable transceiver 500 directly connected, using a wired connection, to the remote device 530. Direct connection can include a connection through a connector, such as a serial communication connector including, but not limited to, a USB connector. Although such a configuration can be straightforward, slight differences in designs can require two similar devices to use two different fixed transceivers such that both devices comply with a desired communication protocol. For example, small layout differences in circuit boards used to couple a serial connector of the device to the transceiver may require two different transceivers in order for each product to comply with a desired communication standard A transceiver (e.g., an adjustable transceiver) according to the present subject matter can provide a single, adjustable component for use with multiple product lines, can provide a certified signal quality in each product line, or can reduce part number inventory across the product lines, thus reducing costs.

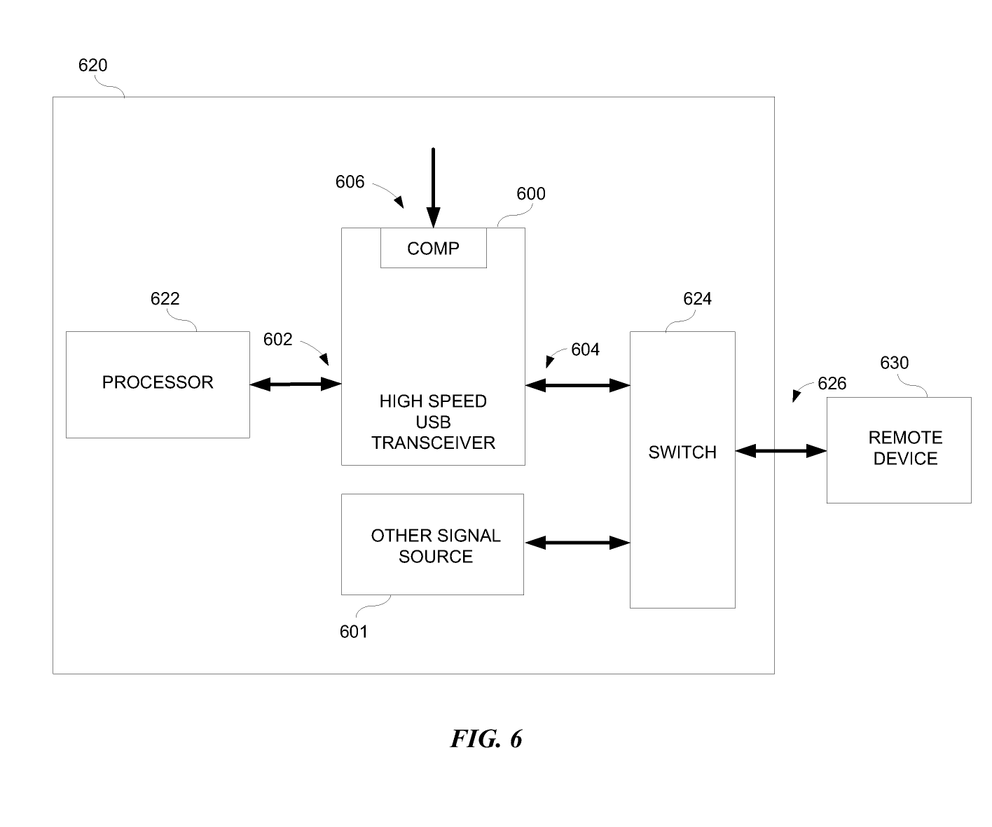

FIG. 6 shows a product 620 including a transceiver 600 according to one example of the present subject matter. The product 620 can be coupled to a remote device 630. The product 620 can include a processor 622, an adjustable transceiver 600, and a switch 624 between the transceiver 600 and a port 626 of the product 620 coupled to the remote device 630. The processor 622 can exchange information with the transceiver 600. The transceiver 600 can transmit and receives signals with the remote device 630 when the transceiver 600 is coupled to the remote device 630 through the switch 624. Transmitted and received signals can include at least a portion of the information exchanged between the transceiver 600 and the processor 622. In various examples, the processor 622 can control the switch 624. The switch 624 can couple the port 626 of the product 620 to the adjustable transceiver 600 and one or more other signal sources 601. For example, in some examples, the switch 624 can couple the port 626 to a configurable high speed USB transceiver 600 in a first state and, in a second state, can connect the port 626 to another signal source 601, such as a full speed USB transceiver. Other wired serial communication transceivers can be coupled to the port 626 through the switch including, but not limited to, other USB transceivers, RS232 transceivers, RS 422 transceivers, RS485 transceivers as well as other wired serial transmitters, receivers or transceivers that are well known in the art. In various examples, the switch 624 can couple other signal sources to the output, including but not limited to, audio signal sources and video signal sources.

In many products, the switch 624 can introduce distortion between a signal source, such as a wired serial communication transceiver 600, and the port 626 of the product 620. In some cases, the distortion is minor and does not interfere with communication between the product 620 and the remote device 630. However, for some wired serial communication standards, the distortion, even though minor, can prevent the product 620 from complying with, and obtaining certification of compliance for, a desired communication standard. In such cases, manufacturers can be limited to the number of features and different product lines a particular transceiver can work with and still maintain certification. Several transceivers with different transmission characteristics may need to be stocked such that the various product lines, the various features, and the various combination of features within a product line can maintain certification with a desired communication standard. Even slight design changes can change electrical characteristics of the connection between the transceiver and the port of the device. For example, modifying a printed circuit board (PCB) layout, or switching PCB suppliers, may require a different transceiver to maintain compliance between the transceiver and the port of the device. Slight changes can introduce enough distortion that the output signal no longer complies with a desired standard. Thus, small modifications can require a manufacturer to change a communication transceiver or to stock several different transceivers to maintain compliance with a desired communication standard.

A transceiver according to the present subject matter can solve these problems. In various examples, the transceiver can include a plurality of compensation settings such that a single transceiver model can work with a broad range of products requiring certification with a desired wired, serial communication standard, such as the High Speed USB 2.0 standard. In various examples, the plurality of settings can be stored in programmable memory. In some examples, the plurality of settings can be hard-coded into the transceiver. In some examples, compensation using the compensation settings can be implemented using software. In some examples, compensation using the compensation settings can be implemented using hardware. In various examples, compensation using the compensation settings can be implemented using a combination of hardware and software.

Selection of a compensation setting for a product can be accomplished using a compensation input of the adjustable transceiver. In various examples, the compensation input can include a terminal. Biasing the terminal with a first reference can select a first compensation setting for generating an output signal of the transceiver. Biasing the terminal with a second reference can select a second compensation setting for generating an output signal of the transceiver. In various examples, the compensation input can provide an indication whether a component is coupled to the output transceiver or not. A compensation setting can be selected based on configuration information received using the compensation input. Providing the ability to adjust the output signal of the transceiver can allow a manufacturer to use a single model of transceiver for a number of products. The transceiver can include a number of selectable compensation settings. In various examples, a compensation setting can be selected based on the components, or lack thereof, coupled to the transceiver. Implementation of the selected compensation setting compensates for distortion of an output signal of the transceiver caused by the components coupled to the transceiver. A compensation setting, in various examples, can be selected to maintain certification of a product according to a desired communication standard. For example, upon installation of an adjustable transceiver within a product, one or more transceiver terminals can be biased to select a particular compensation setting for the transceiver related to particular product within which the transceiver is installed.

In various examples, a selected compensation setting can alter how the serial output signal of the transceiver is generated. For example, in some products a switch can be coupled to the transceiver. The switch can allow a single port of the product to communicate a variety of information, including, but not limited to, wired serial communication information, audio information, and video information. Such a switch can introduce signal distortion. The signal distortion can cause the product to fail certification of a desired wired serial communication standard, such as the “eye” requirements of a standard. In various examples, a compensation setting of an adjustable transceiver can be selected to adjust output signal levels, such as amplitude levels, of the transceiver to maintain the “eye” shape at a remote device. In some examples, “pre-emphasis” can be used to maintain the “eye”. “Pre-emphasis” drives the output harder during the initial transition of a signal and then reduces the “pre-emphasis” as the signal transitions. Such “pre-emphasis” driving of the output signal can compensate for additional impedance introduced by a switch, for example. The amount of pre-emphasis can be different depending on the particular component coupled to the transceiver. For example, a first USB switch coupled to a transceiver can require a first pre-emphasis, or amplitude adjustment setting to maintain the “eye”, but a second USB switch coupled to the same transceiver can require a different setting to maintain the “eye”. The adjustable transceiver can be used with both switches, thus reducing the number of different transceivers a manufacturer needs to stock. Although the transceiver can compensate several different components with a particular “pre-emphasis” setting, in some situations, over driving a switch, or a PCB board, can also provide a non-compliant signal at the port of the product. Additionally, where a compensation setting causes the transceiver to drive an output signal substantially harder than is necessary, use of the product can be substantially reduced. For example, where the product is used under battery power, substantial overdriving can discharge the battery faster than a setting matched to more gently bring the signal into compliance. It is understood that other methods of compensation, in addition to “pre-emphasis” and amplitude adjustment are possible without departing from the scope of the present subject matter.

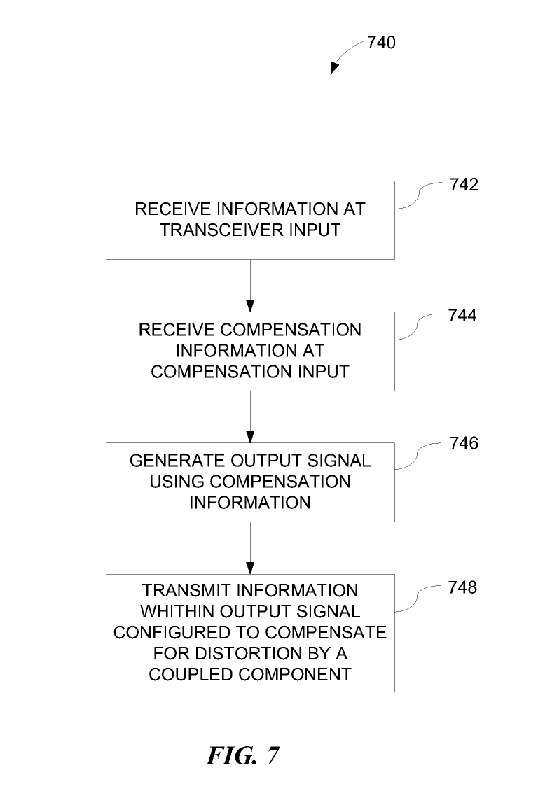

FIG. 7 illustrates generally a method 740 of using an adjustable transceiver according to one example of the present subject matter. The method includes receiving first information at an input of a transceiver 742, receiving compensation information at a compensation input of the transceiver 744, generating an output signal including the first information according to the compensation information 746, and transmitting the first information to a remote device 748. In various examples, generating the output signal includes compensating for distortion of the output signal by a component coupled between the transceiver and the remote device. In some examples, the method includes isolating another signal source from a port of a product and coupling the transceiver to the port using a switch. The other signal sources can include, but are not limited to, other communication transmitters, receivers or transceivers, audio signal sources, video signal sources, or proprietary signal sources.

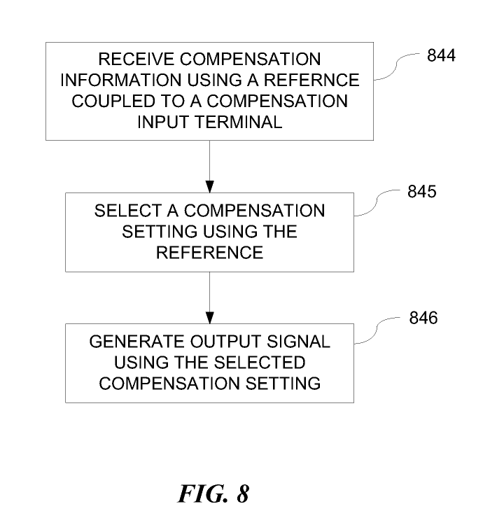

FIG. 8 shows a method for receiving the compensation information and generating an output signal according to one example of the present subject matter. The method for receiving the compensation information can include receiving a reference at a terminal of the transceiver 844. The method for generating the output signal can include selecting a compensation setting from a plurality of compensation settings of the transceiver using the reference 845 and generating the output signal using the selected compensation setting 846.

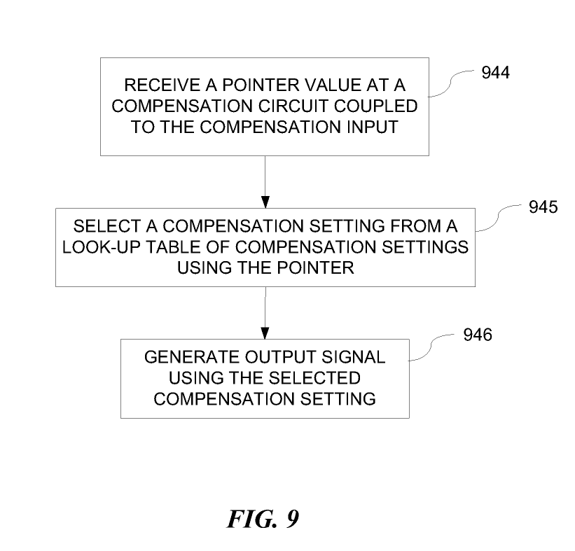

FIG. 9 shows a method for receiving the compensation information and generating an output signal according to one example of the present subject matter. The method for receiving the compensation information can include receiving a pointer value at a compensation register coupled to the compensation input 944. The method for generating the output signal can include selecting a compensation setting from a look-up table of compensation settings of the transceiver using the pointer 945 and generating the output signal using the selected compensation setting 946.

### Additional Notes

The above detailed description includes references to the accompanying drawings, which form a part of the detailed description. The drawings show, by way of illustration, specific examples in which the invention can be practiced. These examples are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other examples can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description, with each claim standing on its own as a separate example. The scope of the invention should be determined with reference to the appended claims, along with the full scope of legal equivalents to which such claims are entitled.

What is claimed is:

1. A transceiver configured for wired serial connection to a remote device, the transceiver comprising:
an input configured to receive first information;
a compensation input configured to receive compensation information;
an output configured to transmit an output signal including the first information to a component coupled between the transceiver and the remote device; and
wherein the transceiver is configured to generate the output signal using the compensation information to maintain a specified signal quality at the remote device.

2. The transceiver of claim 1, wherein the transceiver is configured to use the compensation information to compensate for at least one of amplitude, edge rate, or phase distortion of the output signal by the component.

3. The transceiver of claim 1, wherein the transceiver is configured to compensate for distortion of the output signal by the component.

4. The transceiver of claim 1, wherein the component includes a USB switch to selectively couple the transceiver and the remote device.

5. The transceiver of claim 1, wherein the component includes a USB port.

6. The transceiver of claim 1, wherein the transceiver is configured to adjust the output signal of the transceiver to compensate for signal attenuation at the component.

7. The transceiver of claim 6, wherein the transceiver is configured to compensate for the signal attenuation by increasing transceiver output drive strength and edge rates.

8. The transceiver of claim 1, wherein the compensation input includes a terminal of the transceiver.

9. The transceiver of claim 1, including a selection circuit coupled to the compensation input, wherein the selection circuit includes:
a lookup table having a plurality of positions, the look-up table configured to store one or more compensation settings in the plurality of positions;
a pointer register configured to receive the configuration information; and
wherein the transceiver is configured to generate the output signal according to one or more compensation settings stored in the look-up table at a position related to a value of the pointer register.

10. A system comprising:
a Universal Serial Bus (USB) port; and
a USB transceiver coupled to the port, the transceiver configured for wired USB communication with a remote device, wherein the transceiver includes:
an input configured to receive first information;
a compensation input configured to receive compensation information;
an output configured to generate an output signal including the first information to a component, wherein the component is configured to be coupled between the transceiver and the remote device; and
wherein the USB transceiver is configured to generate using the compensation information to compensate for distortion of the output signal by the component and to maintain a specified signal quality at the remote device.

11. The system of claim 10, including the component, wherein the component is configured to selectively couple the port and the transceiver.

12. The system of claim 11, wherein the component includes a USB switch.

13. The system of claim 11, wherein the compensation input includes a terminal of the transceiver, wherein the terminal is configured to receive a reference and to identify a compensation setting related to the component using the reference.

14. The system of claim 11, including an audio signal; and
wherein the component is configured to selectively couple the audio signal and the port.

15. A method comprising:
receiving first information at an input of a transceiver configured for wired serial connection with a remote device;
receiving compensation information using a compensation input of the transceiver;
generating an output signal including the first information according to the compensation information;
transmitting the first information to the remote device; and
wherein generating the output signal includes compensating for distortion of the transmitted first information by a component coupled between the transceiver and the port.

16. The method of claim 15, wherein the generating includes compensating for at least one of amplitude, edge rate or phase distortion of the output signal by the component.

17. The method of claim 15, wherein the generating includes compensating for a USB switch coupled between the transceiver and the remote device.

18. The method of claim 15, wherein the generating includes adjusting output signal strength to compensate for the component.

19. The method of claim 15, including selectively coupling an output of the USB transceiver and a port.

20. The method of claim 21, wherein the selective coupling includes isolating an audio signal from the port.

21. The method of claim 15, wherein the receiving compensation information includes receiving a reference at a terminal of the transceiver; and
wherein the generating includes selecting a compensation setting from a plurality of compensation settings using the reference.

22. The method of claim 15, wherein the receiving compensation information includes receiving a pointer value at a compensation register coupled to the compensation input; and
wherein the generating includes selecting a compensation setting from a look-up table of compensation settings using the pointer.
